(19) United States
(12) Patent Application Publication
(10) Pub. No.: US 2012/0270079 A1
(43) Pub. Date: Oct. 25, 2012

(54) BROMINE COMPLEX VALVE

(75) Inventor: Alexander Rudolf Winter, Queensland (AU)

(73) Assignee: REDFLOW PTY LTD, Queensland (AU)

(21) Appl. No.: 13/504,227

(22) PCT Filed: Oct. 27, 2010
(86) PCT No.: PCT/AU2010/001430

§ 371 Date: Jul. 16, 2012

(30) Foreign Application Priority Data
Nov. 3, 2009 (AU) 2009905358

(51) Int. Cl. H01M 2/38

(52) U.S. Cl. 429/51; 429/67

(57) ABSTRACT

A zinc-bromine flowing electrolyte battery comprising a negative electrolyte pump to circulate negative electrolyte within a negative electrolyte circulation path, a positive electrolyte pump to circulate positive electrolyte within a positive electrolyte circulation path and having complexed bromine located within a positive electrolyte tank, the positive electrolyte tank in fluid communication with the positive electrolyte circulation path. In use, preferential activation of either of the negative electrolyte pump or the positive electrolyte pump will determine whether positive electrolyte only or a positive electrolyte and complexed bromine mix are circulated within the positive electrolyte circulation path.

### FIELD OF THE INVENTION

The present invention relates to flowing electrolyte batteries. In particular, although not exclusively, the invention relates to a bromine complex valve for a flowing electrolyte battery.

### BACKGROUND TO THE INVENTION

Batteries used in stand alone power supply systems are commonly lead-acid batteries. However, lead-acid batteries have limitations in terms of performance and environmental safety. For example, typical lead-acid batteries often have very short lifetimes in hot climate conditions, especially when they are occasionally fully discharged. Lead-acid batteries are also environmentally hazardous, since lead is a major component of lead-acid batteries and presents environmental challenges during manufacturing and disposal.

Flowing electrolyte batteries, such as zinc-bromine batteries, zinc-chlorine batteries, and vanadium flow batteries, offer the potential to overcome the above mentioned limitations of lead-acid batteries. In particular, the operational lifetime of flowing electrolyte batteries is not affected by deep discharge applications, and the energy to weight ratio of flowing electrolyte batteries is up to six times higher than that of lead-acid batteries.

A flowing electrolyte battery, like a lead acid battery, comprises a stack of cells that produce a total voltage higher than that of individual cells. But unlike a lead acid battery, cells in a flowing electrolyte battery are hydraulically connected through an electrolyte circulation path.

Referring to FIG. 1, a flow diagram illustrates a basic zinc-bromine flowing electrolyte battery 100, as known according to the prior art. The zinc-bromine battery 100 includes a negative electrolyte circulation path 105 and an independent positive electrolyte circulation path 110. The negative electrolyte circulation path 105 contains zinc ions as an active chemical, and the positive electrolyte circulation path 110 contains bromine ions as an active chemical. The zinc-bromine battery 100 also comprises a negative electrolyte pump 115, a positive electrolyte pump 120, a negative zinc electrolyte (anolyte) tank 125, and a positive bromine electrolyte (catholyte) tank 130. A complexing agent is generally added to the bromine electrolyte to form a polybromide complex that reduces the reactivity and vapour pressure of elemental bromine.

To achieve high voltage, the zinc-bromine battery 100 further comprises a stack of cells connected in a bipolar arrangement. For example, a cell 135 comprises half cells 140, 145 including a bipolar electrode plate 155 and a micro porous separator plate 165. The zinc-bromine battery 100 then has a positive polarity end at a collector electrode plate 160, and a negative polarity end at another collector electrode plate 150.

A chemical reaction in a positive half cell, such as the half cell 145, during charging can be described according to the following equation:

2Br⁻→Br₂+2e⁻ Eq. 1.

Bromine is thus formed in half cells in hydraulic communication with the positive electrolyte circulation path 110 and is then stored in the positive bromine electrolyte tank 130. A chemical reaction in a negative half cell, such as the half cell 140, during charging can be described according to the following equation:

Zn²⁺+2e⁻→Zn Eq. 2

A metallic zinc layer 170 is thus formed on the collector electrode plate 150 in contact with the negative electrolyte circulation path 105.

Chemical reactions in the half cells 140, 145 during discharging are the reverse of Eq. 1 and Eq. 2, which means that the complexed bromine stored in the positive bromine electrolyte tank 130 must be made available to the half cells 140 and 145. Typically, the complexed bromine settles at the bottom of positive bromine electrolyte (catholyte) tank 130 and, since it is undesirable to have complexed bromine circulating during charge, the positive electrolyte pump 120 will have an inlet which sits above this level so as to only draw aqueous bromine electrolyte into positive electrolyte circulation path 110. Therefore, a separate bromine complex pump 175 is required to draw complexed bromine from the bottom of the positive bromine electrolyte tank 130 and introduce it into positive electrolyte circulation path 110. As indicated, this pump will only be run during discharge.

Therefore, a fully operational zinc-bromine flowing electrolyte battery will have three separate pumps, or at least two pumps and an electrically operated valve, to ensure the two active electrolyte solutions and the complexed bromine are circulated efficiently and only at the appropriate time. A third pump will draw a significant current during the critical discharge phase of operation, reducing the total battery efficiency. An electrically operated valve may also draw a significant current. In either case an electrical device is employed to control complex bromine flow which may increase costs and complexity and reduce reliability and efficiency of the battery.

### OBJECT OF THE INVENTION

It is therefore an object of the invention to overcome or alleviate at least one of the aforementioned deficiencies in the prior art or at least provide a useful or commercially attractive alternative.

### SUMMARY OF THE INVENTION

In one form, although it need not be the only or indeed the broadest form, the invention resides in a zinc-bromine flowing electrolyte battery comprising:
a negative electrolyte pump to circulate negative electrolyte within a negative electrolyte circulation path;
a positive electrolyte pump to circulate positive electrolyte within a positive electrolyte circulation path;
complexed bromine located within a positive electrolyte tank, the positive electrolyte tank in fluid communication with the positive electrolyte circulation path; and

wherein, in use, preferential activation of either of the negative electrolyte pump or the positive electrolyte pump determines whether positive electrolyte only or a positive electrolyte and complexed bromine mix are circulated within the positive electrolyte circulation path.

Preferably, activation of at, least one of the negative electrolyte pump or the positive electrolyte pump results in pressure actuated switching of an electrolyte flow control mechanism.

Suitably, the electrolyte flow control mechanism comprises a positive electrolyte intake and a positive electrolyte/complexed bromine intake and pressure actuated switching of the electrolyte flow valve causes an increased volume of flow through one with respect to the other.

In a second form the invention resides in a method of regulating the flow of complexed bromine within a positive electrolyte circulation path of a zinc-bromine flowing electrolyte battery including the steps of:
(a) activating one of a negative electrolyte pump or a positive electrolyte pump;
(b) subsequently activating the electrolyte pump which was not activated in step (a); and
wherein, the choice of which of the negative electrolyte pump or the positive electrolyte pump is activated first determines whether a positive electrolyte only or a positive electrolyte and complexed bromine mix are circulated within the positive electrolyte circulation path.

In a third form the invention resides in an electrolyte flow control mechanism for a zinc-bromine flowing electrolyte battery comprising:
(a) a negative electrolyte inlet opening into a negative electrolyte expandable chamber;
(b) a positive electrolyte inlet opening into a positive electrolyte expandable chamber;
(c) a first actuator in communication with a floor of the negative electrolyte expandable chamber and a second actuator in communication with a floor of the positive electrolyte expandable chamber;
(d) cut away portions in each of the first and second actuators capable of aligning with one or more adjacent electrolyte flow apertures; and
wherein, preferential ingress of negative electrolyte or positive electrolyte into the associated expandable chamber causes expansion of the chamber to effect a displacement of the associated actuator such that the cut away portion of the actuator and the adjacent aperture are not in fluid communication.
In a fourth form the invention resides in an electrolyte flow control mechanism for a zinc-bromine flowing electrolyte battery comprising:
(a) a negative electrolyte inlet, a positive electrolyte inlet and a complexed bromine inlet;
(b) a piston having a head, a shaft and an expanded rear portion; and
wherein, preferential flow of negative electrolyte or positive electrolyte through the associated negative or positive electrolyte inlet generates a force against an adjacent face of the piston to displace the piston closer to the other of the negative or positive electrolyte inlet not receiving a flow, thereby causing the piston head to facilitate or prevent the ingress of complexed bromine through the complexed bromine inlet.

In a fifth form the invention resides in an electrolyte flow control mechanism for a zinc-bromine flowing electrolyte battery comprising:
(a) an electrolyte inlet opening into an expandable chamber;
(b) an actuator in communication, at a first end, with a floor of the expandable chamber;
(c) an inlet platform attached to a second end of the actuator;
(d) a positive electrolyte inlet adapted to make a sealing engagement with an upper surface of the inlet platform; and
wherein, preferential activation of an electrolyte pump connected to the electrolyte inlet causes electrolyte to flow into and expand the expandable chamber to thereby displace the actuator and cause the inlet platform to be displaced from the positive electrolyte inlet to allow the influx of positive electrolyte into a positive electrolyte flow tube.

### BRIEF DESCRIPTION OF THE DRAWINGS

To assist in understanding the invention and to enable a person skilled in the art to put the invention into practical effect, preferred embodiments of the invention are described below by way of example only with reference to the accompanying drawings, in which:

FIG. 1 is a diagram illustrating a basic zinc-bromine flowing electrolyte battery, as known according to the prior art;

FIG. 2 is a perspective view of a positive electrolyte pump unit, according to an embodiment of the present invention;

FIG. 3 is a top plan view of the positive electrolyte pump unit shown in FIG. 2;

FIG. 4 is a partial sectional view of a positive electrolyte pump unit flow control mechanism in a neutral position, sectioned along the line A-A shown in FIG. 3, according to an embodiment of the present invention;

FIG. 5A is a partial sectional view of the positive electrolyte pump unit flow control mechanism shown in FIG. 4, in a positive electrolyte intake only operational position;

FIG. 5B is a sectional view of the positive electrolyte pump unit flow control mechanism in FIG. 5A, sectioned along the line C-C shown in FIG. 3;

FIG. 5C is a sectional view of the positive electrolyte pump unit flow control mechanism in FIG. 5A, sectioned along the line B-B shown in FIG. 3;

FIG. 6 is a partial sectional view of the positive electrolyte pump unit flow control mechanism shown in FIG. 4, in a positive electrolyte/complexed bromine mix intake operational position;

FIG. 7A is a top plan view of a bromine complex valve, according to an alternative embodiment of the present invention;

FIG. 7B is a sectional view, along the line A-A shown in FIG. 7A, of a bromine complex valve, in the open bromine complex flow position;

FIG. 7C is a sectional view, along the line A-A shown in FIG. 7A, of a bromine complex valve, in the closed bromine complex flow position;

FIG. 8A is a sectional view of a positive electrolyte flow unit in a closed complexed bromine flow position, according to yet another embodiment of the present invention; and

FIG. 8B is a sectional view of the positive electrolyte flow unit shown in FIG. 8A, in an open complexed bromine flow position.

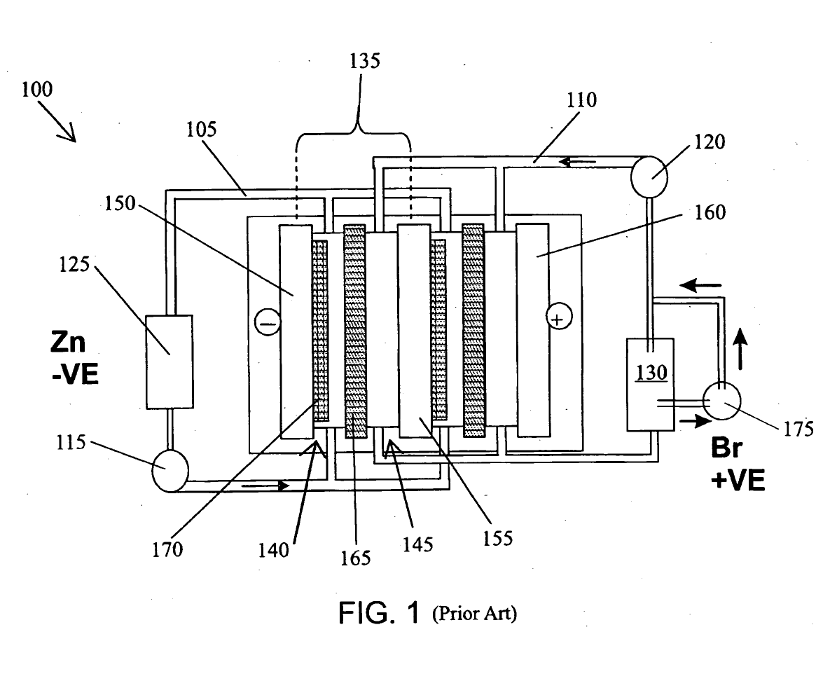

Those skilled in the art will appreciate that minor deviations from the symmetrical layout of components as illustrated in the drawings will not detract from the proper functioning of the disclosed embodiments of the present invention.

### DETAILED DESCRIPTION OF THE INVENTION

Embodiments of the present invention comprise control mechanisms for controlling the positive electrolyte and complexed bromine flow within the positive electrolyte circulation path of a zinc-bromine flowing electrolyte battery. Elements of the invention are illustrated in concise outline form in the drawings, showing only those specific details that are necessary for understanding the embodiments of the present invention, but so as not to clutter the disclosure with excessive detail that will be obvious to those of ordinary skill in the art in light of the present description.

In this patent specification, adjectives such as first and second, left and right, front and back, top and bottom, etc., are used solely to define one element or method step from another element or method step without necessarily requiring a specific relative position or sequence that is described by the adjectives. Words such as “comprises” or “includes” are not used to define an exclusive set of elements or method steps. Rather, such words merely define a minimum set of elements or method steps included in a particular embodiment of the present invention.

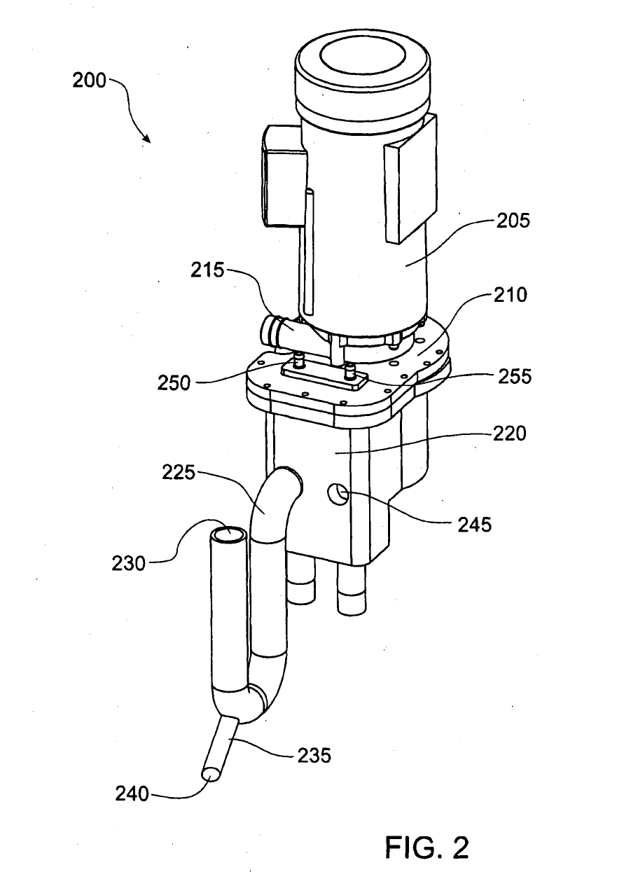

As shown in FIG. 2, positive electrolyte flow unit 200 comprises a pump motor 205 of a positive electrolyte pump and an electrolyte flow valve housing 220 separated by a platform 210. Located between pump motor 205 and platform 210 is a positive electrolyte outlet 215 which allows positive electrolyte to exit positive electrolyte flow unit 200 and enter a positive electrolyte circulation path.

Extending from electrolyte flow valve housing 220 is a positive electrolyte and complexed bromine inlet tube 225 which takes the form of a U-bend and ends at an upper extent in first inlet tube aperture 230. Located adjacent the lower extent of the U-bend of positive electrolyte and complexed bromine inlet tube 225 is complexed bromine inlet tube 235 into which complexed bromine can enter via second inlet tube aperture 240. Complexed bromine inlet tube 235 opens into the hollow interior of positive electrolyte and complexed bromine inlet tube 225.

As will be demonstrated later, positive electrolyte flow unit 200 will sit within a positive electrolyte tank (not shown in the figures) such that first inlet tube aperture 230 is submerged within and opens into the positive electrolyte but sits above the level of the complexed bromine. Second inlet tube aperture 240 is submerged within and opens into the complexed bromine which accumulates at the bottom of the positive electrolyte tank. This means that when positive electrolyte is drawn into positive electrolyte and complexed bromine inlet tube 225 through first inlet tube aperture 230, due to the action of the positive electrolyte pump, it flows past the end of complexed bromine inlet tube 235 which opens into positive electrolyte and complexed bromine inlet tube 225. At this point the positive electrolyte (aqueous) mixes with the complexed bromine, which has been drawn through complexed bromine inlet tube 235 due to the positive electrolyte pump pressure, and both enter electrolyte flow valve housing 220 through positive electrolyte and complexed bromine inlet tube 225.

Disposed adjacent positive electrolyte and complexed bromine inlet tube 225 on electrolyte flow valve housing 220 is a positive electrolyte inlet 245 which, in the embodiment shown in FIG. 2, simply takes the form of an aperture within electrolyte flow valve housing 220. Positive electrolyte inlet 245 is located at a similar vertical height to first inlet tube aperture 230 and so, in use, will be submerged within the positive electrolyte but above the level of the complexed bromine. This means that when the positive electrolyte pump draws liquid through positive electrolyte inlet 245 only positive electrolyte, and not complexed bromine, can enter electrolyte flow valve housing 220.

Negative electrolyte valve control inlet 250 and positive electrolyte valve control inlet 255 are located adjacent one another on platform 210. Negative electrolyte valve control inlet 250 is connected to a high pressure outlet of a negative electrolyte pump of the zinc-bromine flowing electrolyte battery and positive electrolyte valve control inlet 255 is likewise connected to a high pressure outlet of the positive electrolyte pump. For the sake of clarity these connections are not shown in the figures but they result in a high pressure stream of negative electrolyte entering negative electrolyte valve control inlet 250 when the negative electrolyte pump is switched on, and a high pressure stream of positive electrolyte entering positive electrolyte valve control inlet 255 when the positive electrolyte pump is switched on. The effect of this high pressure supply of positive and/or negative electrolyte will be described in greater depth hereinafter.

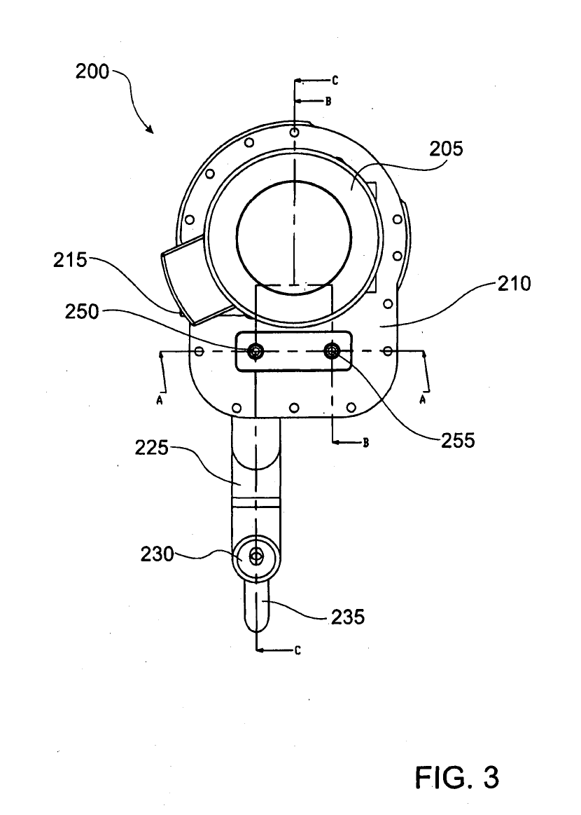

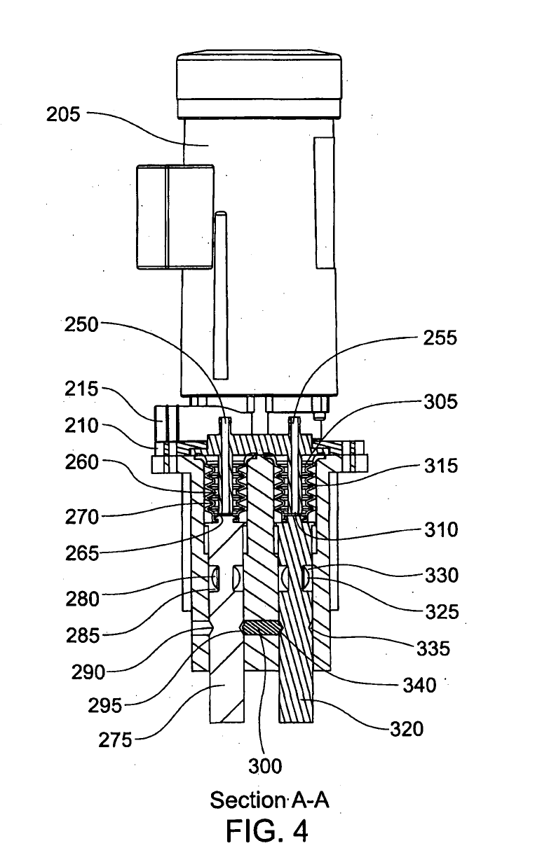

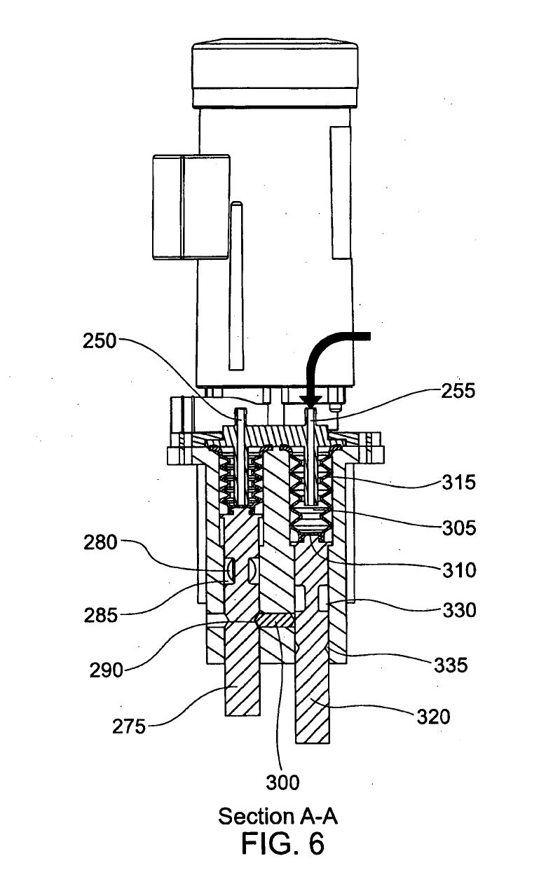

Referring now to FIG. 3, pump motor 205, positive electrolyte outlet 215 and negative and positive electrolyte pressure inlets 250 and 255, respectively, can be seen to sit on top of platform 210. Positive electrolyte and complexed bromine inlet tube 225 is seen to extend from the body of positive electrolyte flow unit 200 and the opening of complexed bromine inlet tube 235 into positive electrolyte and complexed bromine inlet tube 225 can be seen through first inlet tube aperture 230. FIG. 3 indicates sectional lines A-A, B-B and C-C which will be referred to and viewed in FIG. 4 through to FIG. 6.

FIG. 4 is a partial sectional view along the line A-A shown in FIG. 3 and demonstrates one embodiment of an electrolyte flow control mechanism within positive electrolyte flow unit 200. In the embodiment shown in FIG. 4 the electrolyte flow control mechanism is in what can be termed the neutral position as neither the negative or positive electrolyte pump has been activated.

Negative electrolyte valve control inlet 250 opens, at its lower extent, into a negative electrolyte chamber 260 which is defined by a negative electrolyte chamber base 265, a negative electrolyte chamber wall 270 and platform 210. In the embodiment shown, negative electrolyte chamber wall 270 takes the form of ribbed expandable bellows but any expandable chamber design may be appropriate. In the neutral position the lower extent of negative electrolyte valve control inlet 250 sits adjacent negative electrolyte chamber base 265 which is in contact at its lower surface with a bromine complex actuator 275. A bromine complex aperture 280 can be seen exposed through a bromine complex actuator recess 285 within bromine complex actuator 275 since the two are in alignment in FIG. 4. Bromine complex aperture 280 is in fluid communication with positive electrolyte and complexed bromine inlet tube 225 and so, in the position shown, if a driving force were present, the flow of positive electrolyte and complexed bromine through bromine complex aperture 280 would be unimpeded.

Below the position of bromine complex actuator recess 285 on bromine complex actuator 275 is a bromine complex actuator notch 290 which is shaped to receive a first angled face 295 of locking bar 300. Locking bar 300 is seen to sit such that, in the neutral position, first angled face 295 is not engaging bromine complex actuator notch 290 and so the potential movement of bromine complex actuator 275 is unrestricted.

The layout just described in relation to the positive electrolyte and complexed bromine flow control mechanism is repeated for the positive electrolyte only flow control mechanism. Positive electrolyte valve control inlet 255 opens, at its lower extent, into a positive electrolyte chamber 305 defined by a positive electrolyte chamber base 310, a positive electrolyte chamber wall 315 and platform 210. The lower extent of positive electrolyte valve control inlet 255 sits adjacent positive electrolyte chamber base 310 which is in contact at its lower surface with a positive electrolyte actuator 320. In the neutral position shown in FIG. 4 a positive electrolyte aperture 325 sits in alignment with a positive electrolyte actuator recess 330. Positive electrolyte aperture 325 is located in fluid communication with positive electrolyte inlet 245. In this position, if a driving force were present, the flow of positive electrolyte through positive electrolyte inlet 245 and positive electrolyte aperture 325 would be unimpeded.

Below the position of positive electrolyte actuator recess 330 on positive electrolyte actuator 320 is a positive electrolyte actuator notch 335 adapted to receive a second angled face 340 of locking bar 300. It will now be apparent that locking bar 300 is free to slide to the left or right to engage with either of bromine complex actuator notch 290 or positive electrolyte actuator notch 335. Locking bar 300 is sized such that, in operation, either of bromine complex actuator 275 or positive electrolyte actuator 320 must be locked.

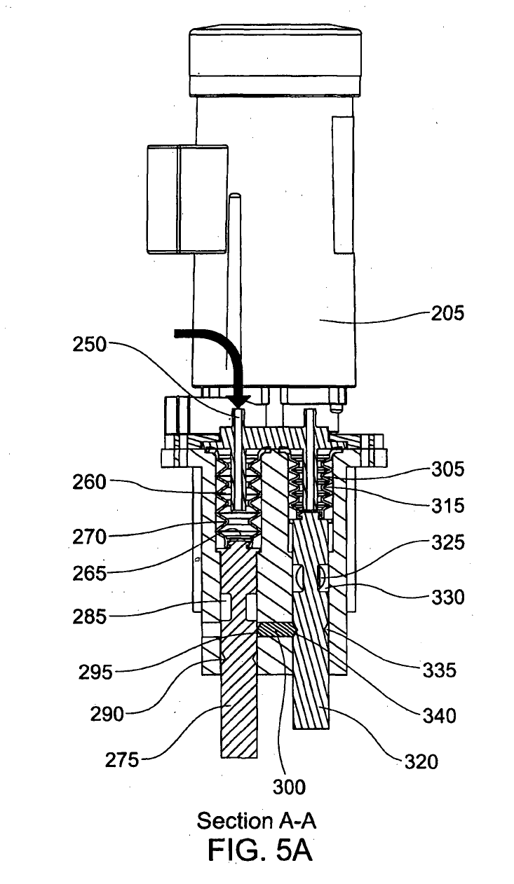

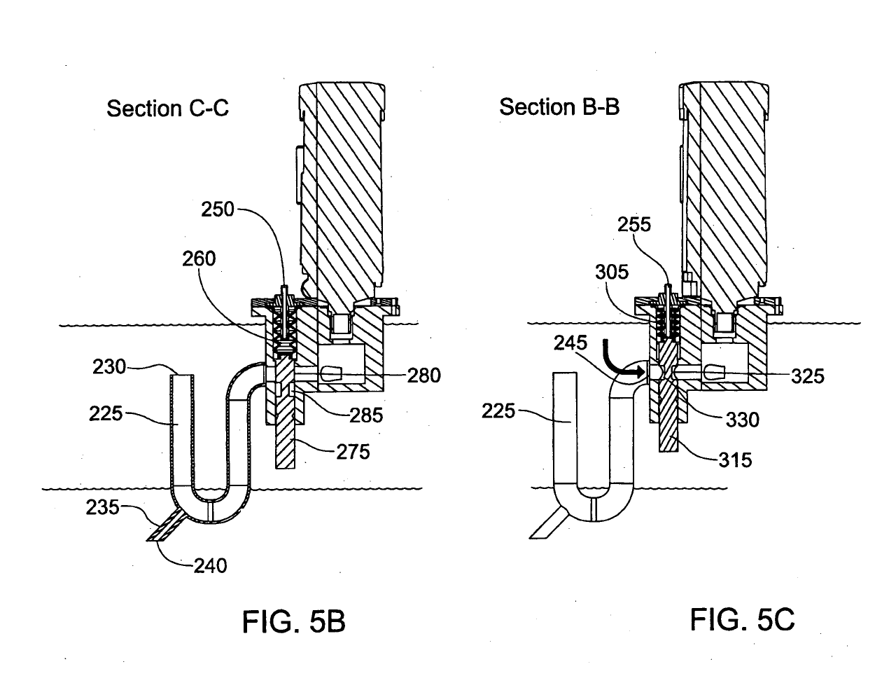

FIG. 5A is a partial sectional view of the electrolyte flow control mechanism shown in FIG. 4 but in a positive electrolyte intake only, operational position. Specifically, in the embodiment shown in FIG. 5A, the negative electrolyte pump (not shown) has been activated before activation of the positive electrolyte pump connected to pump motor 205. This has had the effect that negative electrolyte from a high pressure fluid circuit leaving the negative electrolyte pump is introduced through negative electrolyte valve control inlet 250 into negative electrolyte chamber 260. As the negative electrolyte fills negative electrolyte chamber 260 the internal pressure therein is raised and negative electrolyte chamber wall 270 expands in a generally downward manner thereby exerting a downward force on negative electrolyte chamber base 265. This in turn forces bromine complex actuator 275 to move downwards such that bromine complex actuator recess 285 is no longer in alignment with bromine complex aperture 280 which, consequently, cannot be seen in FIG. 5A. This results in the fluid flow of positive electrolyte and complexed bromine from positive electrolyte and complexed bromine inlet tube 225 into bromine complex aperture 280 being interrupted and so complexed bromine will not be pumped out from positive electrolyte flow unit 200.

The downward motion of bromine complex actuator 275 causes the second angled face 340 of locking bar 300 to be forced into engagement with positive electrolyte actuator notch 335. Thus, when the positive electrolyte pump is subsequently activated and positive electrolyte from a high pressure fluid circuit exiting the positive electrolyte pump is introduced into positive electrolyte chamber 305 the change in internal pressure therein is unable to effect a downward movement of positive electrolyte actuator 320 due to a side wall of bromine complex actuator 275 preventing locking bar 300 from shifting leftwards to exit positive electrolyte actuator notch 335. This results in positive electrolyte aperture 325 being forced to remain open to the flow of positive electrolyte introduced through positive electrolyte inlet 245.

It should be clear that, in the embodiment shown in FIG. 5A, activating the negative electrolyte pump prior to activation of the positive electrolyte pump results in only positive electrolyte being pumped out of positive electrolyte flow unit 200. This would be appropriate when the zinc-bromine flowing electrolyte battery is being charged. Clearly, if the supply of high pressure electrolyte to negative and positive electrolyte pressure inlets 250 and 255, respectively, were to be swapped then the order in which the negative and positive electrolyte pumps would need to be activated would be reversed.

FIG. 5B is a sectional view of the positive electrolyte flow unit 200 in FIG. 5A, sectioned along the line C-C shown in FIG. 3. Thus, as for FIG. 5A, the negative electrolyte pump was activated first and so the flow control mechanisms are such that the flow of positive electrolyte and complexed bromine from positive electrolyte and complexed bromine inlet tube 225 is prevented from entering bromine complex aperture 280. The downward displacement of bromine complex actuator recess 285 such that it is no longer in alignment with the opening of positive electrolyte and complexed bromine inlet tube 225 into pump motor 205 is clearly visible. The upper fluid level mark in FIG. 5B is that of the positive electrolyte while the lower fluid mark is that of the complexed bromine within the positive electrolyte tank.

FIG. 5C is a sectional view of the positive electrolyte flow unit 200 in FIG. 5A, sectioned along the line B-B shown in FIG. 3. This particular section passes through positive electrolyte inlet 245 and it is seen to be in alignment with positive electrolyte actuator recess 330 and positive electrolyte aperture 325. This creates an unbroken flow path for positive electrolyte which will be pumped out of positive electrolyte flow unit 200 and into the positive electrolyte circulation path.

FIG. 6 is the same partial sectional view of the positive electrolyte flow unit 200 shown in FIG. 4 but in a positive electrolyte and complexed bromine mix intake, operational position. The difference in the flow intake in this embodiment compared to that shown in FIG. 4 is a result of the positive electrolyte pump being activated prior to activation of the negative electrolyte pump. Thus, high pressure positive electrolyte entered positive electrolyte chamber 305 and effected an expansion of positive electrolyte chamber wall 315 which brought about a corresponding downward movement of positive electrolyte actuator 320. This movement causes positive electrolyte actuator recess 330 to be out of alignment with positive electrolyte aperture 325 and prevents the flow of positive electrolyte from positive electrolyte inlet 245 therethrough.

The movement of positive electrolyte actuator 320 also causes the leftwards motion of locking bar 300 such that first angled face 295 of locking bar 300 engages with bromine complex actuator notch 290. Locking bar 300 is effectively locked in this position while the flow of high pressure positive electrolyte into positive electrolyte chamber 305 is maintained. This results in bromine complex actuator 275 being unable to move such that bromine complex actuator recess 285 is maintained in alignment with bromine complex aperture 280 thereby allowing the flow of both positive electrolyte and complexed bromine received from positive electrolyte and complexed bromine inlet tube 225 into bromine complex aperture 280. This will result in positive electrolyte and complexed bromine being pumped out of positive electrolyte flow unit 200 into the positive electrolyte circulation path. This embodiment of the flow control mechanism would, therefore, be appropriate for use during a discharge cycle of the zinc-bromine flowing electrolyte battery.

The embodiments of positive electrolyte flow unit 200 described in relation to FIGS. 4 to 6 are particularly suitable for zinc-bromine flowing electrolyte battery systems which employ low pump rates and low pump pressures due to the inherently low internal friction of the actuating components described and due to the positive locking aspect of the actuators during pump operation.

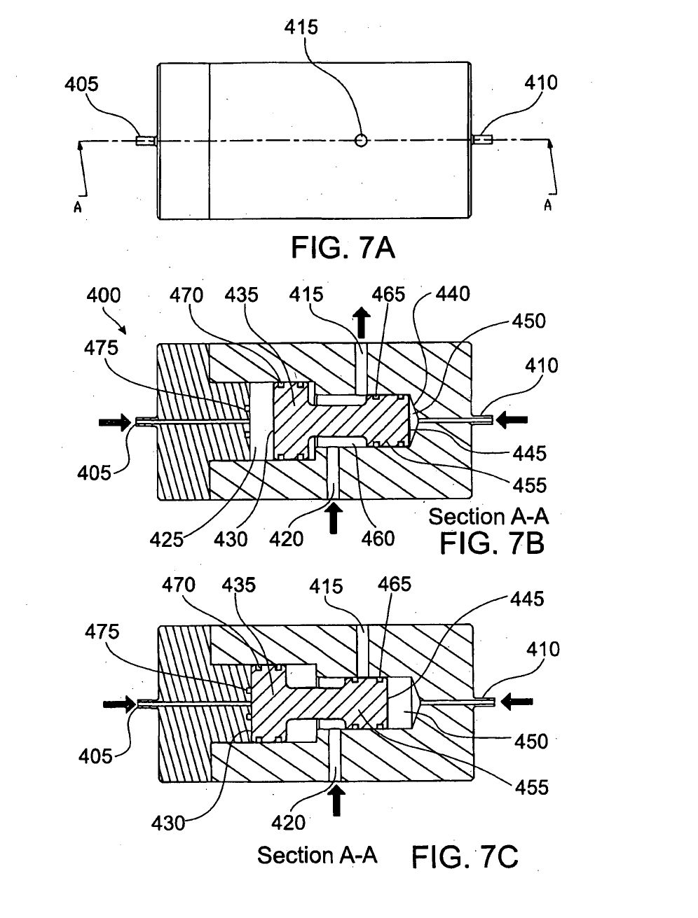

FIG. 7A is a top plan view of a bromine complex valve 400, according to an alternative embodiment of the present invention. Bromine complex valve 400 comprises a negative electrolyte inlet 405, a positive electrolyte inlet, 410 and a bromine complex outlet 415. Negative electrolyte inlet 405 receives negative electrolyte from a fluid circuit originating at the negative electrolyte pump and positive electrolyte inlet 410 receives positive electrolyte from a fluid circuit originating at the positive electrolyte pump. FIG. 7A demonstrates the line A-A through which a section is taken for FIGS. 7B and 7C.

FIG. 7B is a sectional view, along the line A-A shown in FIG. 7A, of a bromine complex valve 400, in the open bromine complex flow position. Once again, negative electrolyte inlet 405, positive electrolyte inlet 410 and bromine complex outlet 415 can all be seen. In addition, bromine complex inlet 420 is shown. In this embodiment the negative electrolyte pump has been activated before the positive electrolyte pump (pumps not shown). This causes a small stream of negative electrolyte to pass through negative electrolyte inlet 405 and enter negative electrolyte chamber 425 which expands due to the force of negative electrolyte contacting a negative electrolyte face 430 of a piston 435 thereby forcing piston 435 to move in a direction away from negative electrolyte inlet 405.

This movement of piston 435 brings it closer to angled face 440 and further movement is prevented when a positive electrolyte face 445 of piston 435 encounters the outer extent of angled face 440. Positive electrolyte face 445 and angled face 440 define a positive electrolyte chamber 450 into which positive electrolyte inlet 410 opens. Piston 435 has a head portion 455 which is reduced in size by comparison to the opposite end of piston 435 which presents negative electrolyte face 430 and so the surface area of positive electrolyte face 445 presented to positive electrolyte entering positive electrolyte chamber 450 from positive electrolyte inlet 410 is less than that presented by negative electrolyte face 430 to the negative electrolyte. This means that, when the negative electrolyte pump has been activated first, subsequent activation of the positive electrolyte pump will not cause piston 435 to move away from angled face 440 to any notable extent.

The position that piston 435 has been forced to take due to the influx of negative electrolyte is such that an unbroken flow path is created for positive electrolyte and complexed bromine to enter into a central chamber 460 through bromine complex inlet 420 and to exit via bromine complex outlet 415. Bromine complex outlet 415 leads to the positive electrolyte pump and so, in the embodiment shown in FIG. 7B wherein the negative electrolyte pump was activated before the positive electrolyte pump, positive electrolyte and complexed bromine will be pumped into the positive electrolyte circulation path. This is appropriate for a discharge cycle of the zinc-bromine flowing electrolyte battery.

FIG. 7C is a sectional view, along the line A-A shown in FIG. 7A, of a bromine complex valve 400, in the closed bromine complex flow position. In this embodiment the positive electrolyte pump has been activated prior to activation of the negative electrolyte pump. Positive electrolyte has therefore passed through positive electrolyte inlet 410 into positive electrolyte chamber 450 and, acting on positive electrolyte face 445, has forced piston 435 to move away from angled face 440 until negative electrolyte face 430 abuts the housing of bromine complex valve 400. In this position the volume of negative electrolyte chamber 425 has been substantially reduced to be practically absent.

The movement caused by the influx of positive electrolyte results in head portion 455 being positioned to block the flow of positive electrolyte and complexed bromine mix from central chamber 460 into bromine complex outlet 415. The positive electrolyte pump will receive only positive electrolyte from a separate source (not shown in the figures) and so the embodiment shown in FIG. 7C is suitable for a charge cycle of the zinc-bromine flowing electrolyte battery.

When the negative electrolyte pump is subsequently switched on, negative electrolyte passes into negative electrolyte inlet 405 and contacts negative electrolyte face 430 of piston 435. It will be appreciated that the negative electrolyte can only act against a restricted surface area of negative electrolyte face 430 due, in part, to the size of the bore of negative electrolyte inlet 405. The surface area of negative electrolyte face 430 receiving negative electrolyte is further restricted by negative electrolyte inlet seal 475 which surround the opening of negative electrolyte inlet 405 into negative electrolyte chamber 425. When negative electrolyte face 430 of piston 435 is forced against negative electrolyte inlet seal 475, as shown in FIG. 7C, the result is a sealing engagement such that negative electrolyte cannot force its way through and into contact with a greater area of negative electrolyte face 430.

This results in the positive electrolyte generating a pressure across a much greater surface area of positive electrolyte face 445, and hence a greater force, than is being generated by negative electrolyte across negative electrolyte face 430. Thus, the subsequent activation of the negative electrolyte pump cannot overcome this force and so does not result in any substantial shift of piston 435 and the flow of complexed bromine through bromine complex valve 400 remains impeded.

The embodiments of a bromine complex valve 400 shown in FIG.'s 7A to 7C are particularly suitable for zinc-bromine battery flow systems which operate at relatively high pump pressures as a certain minimum pressure is required to overcome the sliding O-ring friction provided by the use of sliding O-rings 465 and 470 on piston 435. These O-rings effectively seal the negative and positive electrolyte inlets 405 and 410, respectively, from central chamber 460.

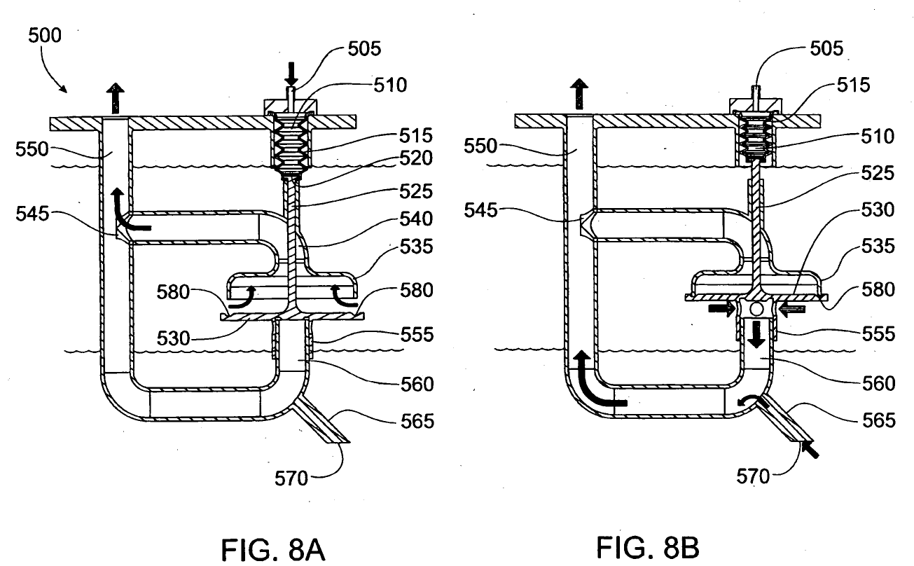

FIG. 8A is a sectional view of a positive electrolyte flow unit 500 in a closed complexed bromine flow position, according to yet another embodiment of the present invention. The upper fluid level mark in FIG. 8A is that of the positive electrolyte while the lower fluid mark is that of the complexed bromine within the positive electrolyte tank. In the embodiment shown in FIG. 8A the negative electrolyte pump has been activated before activation of the positive electrolyte pump. This results in negative electrolyte flowing into a negative electrolyte inlet 505 from an outlet of the negative electrolyte pump. The negative electrolyte then enters a negative electrolyte chamber 510 which is defined by a chamber wall 515 and a chamber base 520. In the embodiment shown, chamber wall 515 takes the form of expandable bellows.

An actuator 525 is connected at its upper extent to the underside of chamber base 520 and at its lower extent ends in an inlet platform 530. Inlet platform 530, in FIG. 8A, sits adjacent but not in contact with a positive electrolyte inlet 535. The arrows in FIG. 8A adjacent positive electrolyte inlet 535 indicate the flow of positive electrolyte through positive electrolyte inlet 535 and into a first positive electrolyte flow tube 540. First positive electrolyte flow tube 540 connects via a T-piece connector 545 to a supply tube 550. Supply tube 550 supplies positive electrolyte or a positive electrolyte and complexed bromine mix to the positive electrolyte pump and so supply tube 550 is under negative pressure due to the operation of that pump. This aids in drawing positive electrolyte or a positive electrolyte and complexed bromine mix into the positive electrolyte pump.

In the embodiment shown in FIG. 8A inlet platform 530 has been forced in a generally downwards direction. This results in a like motion of a sliding sleeve 555 which is attached to the underside of inlet platform 530 and can be seen in more detail in FIG. 8B. Sliding sleeve 555 is provided with a number of inlet holes around its exterior (not visible in FIG. 8A). Inlet platform 530 thus sits adjacent a second positive electrolyte flow tube 560. Second positive electrolyte flow tube 560 forms a U-bend at its lower extent and is intersected by bromine complex inlet tube 565 which opens into the complexed bromine within the positive electrolyte tank at inlet aperture 570. Second positive electrolyte flow tube 560 then continues past T-piece connector 545 to be continuous with supply tube 550.

The effect of switching on the negative electrolyte pump first is to have negative electrolyte entering negative electrolyte chamber 510 and expanding chamber wall 515 which results in chamber base 520 being forced downwards. This moves actuator 525, and thus inlet platform 530 and sliding sleeve 555 with it, to leave the inlet holes of sliding sleeve 555 aligned with the solid exterior of second positive electrolyte flow tube 560 thereby preventing the ingress of positive electrolyte therethrough. Positive electrolyte can only enter the positive electrolyte pump through positive electrolyte inlet 535 and so second positive electrolyte flow tube 560 and bromine complex inlet tube 565 are bypassed. The negative pressure exerted by the positive electrolyte pump, once it is subsequently switch on, is insufficient to overcome the downward force exerted by the negative electrolyte in negative electrolyte chamber 510 due to the size of the gap already formed between inlet platform 530 and positive electrolyte inlet 535 and the influx of positive electrolyte therein.

This results in only positive electrolyte being pumped into the positive electrolyte circulation path and so the embodiment shown in FIG. 8A is suitable for a charge cycle of the zinc-bromine flowing electrolyte battery.

FIG. 8B is a sectional view of the positive electrolyte flow unit 500 shown in FIG. 8A, in an open bromine complex flow position. In this embodiment the positive electrolyte pump has been activated prior to activation of the negative electrolyte pump. The operation of the positive electrolyte pump results in a negative pressure in first positive electrolyte flow tube 540. Since there is no downward force being exerted on actuator 525, positive electrolyte inlet 535 contacts inlet platform 530 and sits within a groove 580 to form a sealing contact and is held strongly in this position by the negative pressure discussed and by the large surface area over which this pressure is applied.

The position of inlet platform 530 means that attached sliding sleeve 555 is moved generally upwards in relation to its position in FIG. 8A. This means that the inlet holes provided on sliding sleeve 555 are now aligned with the open space above the beginning of second positive electrolyte flow tube 560 and, as indicated by arrows in FIG. 8B, positive electrolyte is able to enter therethrough. This flow of positive electrolyte passes down second positive electrolyte flow tube 560 past the opening of complex inlet tube 565. It is at this point that complexed bromine is drawn into second positive electrolyte flow tube 560 to mix with the positive electrolyte. This mix of positive electrolyte and complexed bromine then continues into supply tube 550 and thus into the positive electrolyte pump. The small pressure drop along second positive electrolyte flow tube 560 ensures there is sufficient negative pressure at T-piece connector 545 and within first positive electrolyte flow tube 540 to maintain inlet platform 530 in sealing contact with positive electrolyte inlet 535.

This results in a positive electrolyte and complexed bromine mix being pumped into the positive electrolyte circulation path and so the embodiment shown in FIG. 8B is suitable for a discharge cycle of the zinc-bromine flowing electrolyte battery.

When the negative electrolyte pump is subsequently switched on the downward force generated on actuator 525 by the influx of negative electrolyte into negative electrolyte chamber 510 is not sufficient to displace inlet platform 530 from within groove 580 of positive electrolyte inlet 535 due to the suction force between the two components generated by the negative pressure in first positive electrolyte flow tube 540 and the large difference between the surface area of inlet platform 530 and chamber base 520.

The embodiments of a positive electrolyte flow unit 500 described in FIGS. 8A and 8B are particularly suitable for application in a zinc-bromine flowing electrolyte battery which employs positive and negative electrolyte pumps with high volume flow rates to ensure the positive electrolyte pump generates sufficient negative pressure to hold inlet platform 530 and positive electrolyte inlet 535 in sealing contact when the positive electrolyte pump has been activated prior to the negative electrolyte pump.

It will be appreciated that a number of embodiments of positive electrolyte and complexed bromine flow control mechanisms have been described herein. They all operate to afford control over whether the positive electrolyte pump will pump positive electrolyte only or a positive electrolyte and complexed bromine mix into the positive electrolyte circulation path. The control is achieved simply by the choice of which of the positive electrolyte pump or the negative electrolyte pump is activated first.

The invention described herein obviates the need for a third pump dedicated to pumping complexed bromine or a dedicated electrically operated valve and so offers savings in manufacturing costs as well as enabling the zinc-bromine flowing electrolyte battery to be more compact and have an improved overall efficiency. Further savings are likely for the consumer due to improved reliability of the battery resulting from reduced complexity through dispensing with the need for the third pump and reducing of the amount of complex electronics required.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Specifically, wherein certain embodiments have components such as expandable chambers, inlet chambers and the like which have been described as receiving either of a negative electrolyte flow or a positive electrolyte flow it will be appreciated that tubing supplying such flow may simply be swapped over such that those chambers would now receive the opposite of their former negative or positive electrolyte flow. The main implication such a change would have would be that the order in which the negative or positive electrolyte pumps need to be started to achieve a desired outcome may be reversed. Given the present disclosure, such a change and the implications thereof would be easily comprehended by a person of skill in the art.

Accordingly, while some alternative embodiments have been discussed specifically, other embodiments will be apparent or relatively easily developed by those of ordinary skill in the art. Accordingly, this patent specification is intended to embrace all alternatives, modifications and variations of the present invention that have been discussed herein, and other embodiments that fall within the spirit and scope of the above described invention.

1. A zinc-bromine flowing electrolyte battery comprising:
a negative electrolyte pump to circulate negative electrolyte within a negative electrolyte circulation path;
a positive electrolyte pump to circulate positive electrolyte within a positive electrolyte circulation path;
complexed bromine located within a positive electrolyte tank, the positive electrolyte tank in fluid communication with the positive electrolyte circulation path; and
wherein, in use, preferential activation of either of the negative electrolyte pump or the positive electrolyte pump determines whether positive electrolyte only or a positive electrolyte and complexed bromine mix are circulated within the positive electrolyte circulation path.

2. The zinc-bromine flowing electrolyte battery of claim 1 wherein activation of at least one of the negative electrolyte pump or the positive electrolyte pump results in pressure actuated switching of an electrolyte flow control mechanism.

3. The zinc-bromine flowing electrolyte battery of claim 2 wherein the electrolyte flow control mechanism comprises a positive electrolyte intake and a positive electrolyte/complexed bromine combined intake and pressure actuated switching of the electrolyte flow valve causes an increased volume of flow through one with respect to the other.

4. The zinc-bromine flowing electrolyte battery of claim 2 or claim 3 wherein the electrolyte flow control mechanism further comprises a negative electrolyte inlet and a positive electrolyte inlet.

5. The zinc-bromine flowing electrolyte battery of claim 4 wherein the negative electrolyte inlet opens into a negative electrolyte expandable chamber and the positive electrolyte inlet opens into a positive electrolyte expandable chamber.

6. The zinc-bromine flowing electrolyte battery of claim 5 further comprising a separate actuator in communication with a floor of each of the negative electrolyte expandable chamber and positive electrolyte expandable chamber, each actuator comprising at least one cut away portion to facilitate electrolyte flow therethrough.

7. (canceled)

8. The zinc-bromine flowing electrolyte battery of claim 6 wherein each actuator further comprises at least one notch for receiving a complimentary face of a slidable locking bar which is adapted to individually engage with either of the actuators to restrict the movement thereof.

9. (canceled)

10. The zinc-bromine flowing electrolyte battery of claim 6 wherein each of the cut away portions of the respective actuators can be aligned with one or more electrolyte flow apertures for the flow of positive electrolyte or a positive electrolyte/complexed bromine mix.

11. The zinc-bromine flowing electrolyte battery of claim 10 wherein preferential activation of the negative electrolyte pump causes an influx of high pressure negative electrolyte into the negative electrolyte expandable chamber to thereby expand said chamber and cause movement of the associated actuator such that the actuator cut away portion is not in alignment with its associated electrolyte flow aperture to thereby prevent the flow of positive electrolyte or a positive electrolyte/complexed bromine mix therethrough.

12. (canceled)

13. The zinc-bromine flowing electrolyte battery of claim 11 wherein movement of the actuator causes the locking bar to slidingly engage the notch of the stationary actuator.

14. The zinc-bromine flowing electrolyte battery of claim 10 wherein preferential activation of the positive electrolyte pump causes an influx of high pressure positive electrolyte into the positive electrolyte expandable chamber to thereby expand said chamber and cause movement of the associated actuator such that the actuator cut away portion is not in alignment with its associated electrolyte flow aperture to thereby prevent the flow of positive electrolyte or a positive electrolyte/complexed bromine mix therethrough.

15. (canceled)

16. The zinc-bromine flowing electrolyte battery of claim 14 wherein movement of the actuator causes the locking bar to slidingly engage the notch of the stationary actuator.

17. The zinc-bromine flowing electrolyte battery of claim 4 further comprising a piston having a head, a shaft and an expanded rear portion, a negative electrolyte face adjacent the negative electrolyte inlet and a positive electrolyte face adjacent the positive electrolyte inlet.

18. (canceled)

19. The zinc-bromine flowing electrolyte battery of claim 17 wherein preferential activation of either of the negative or positive electrolyte pumps causes the flow of electrolyte through the associated electrolyte inlet to generate a force against the adjacent positive or negative electrolyte face to displace the piston closer to the other electrolyte inlet.

20. The zinc-bromine flowing electrolyte battery of claim 19 wherein movement of the piston causes the piston head to either block or be displaced from a complexed bromine inlet to thereby prevent or facilitate the flow of complexed bromine.

21. The zinc-bromine flowing electrolyte battery of claim 20 wherein the subsequent activation of the previously inactive pump does not cause a substantial displacement of the piston due to the associated electrolyte being limited to contacting a smaller surface area of the piston.

22. The zinc-bromine flowing electrolyte battery of claim 2 wherein the electrolyte flow control mechanism further comprises an electrolyte inlet which opens into an expandable chamber having an actuator in communication, at a first end, with a floor of the expandable chamber.

23. (canceled)

24. (canceled)

25. The zinc-bromine flowing electrolyte battery of claim 22 wherein a second end of the actuator is attached to an inlet platform having an upper surface adapted to make a sealing engagement with a positive electrolyte inlet and a lower surface in contact with a slidable sleeve.

26. (canceled)

27. (canceled)

28. The zinc-bromine flowing electrolyte battery of claim 25 wherein the slidable sleeve comprises one or more apertures for the ingress of positive electrolyte into an associated flow tube, the flow tube being intersected by a complexed bromine inlet and the flow tube being in fluid communication with the positive electrolyte circulation path.

29. (canceled)

30. (canceled)

31. The zinc-bromine flowing electrolyte battery of claim 28 wherein preferential activation of an electrolyte pump in fluid communication with the electrolyte inlet causes electrolyte to flow into the expandable chamber to thereby force the actuator in a generally downwards direction and cause the inlet platform to be displaced from the positive electrolyte inlet to allow the influx of positive electrolyte into a positive electrolyte flow tube.

32. The zinc-bromine flowing electrolyte battery of claim 31 wherein the displacement of the inlet platform causes the slidable sleeve to be displaced such that the one or more apertures are closed to electrolyte flow.

33. The zinc-bromine flowing electrolyte battery of claim 28 wherein preferential activation of an electrolyte pump not in fluid communication with the electrolyte inlet causes the inlet platform to be in sealing engagement with the positive electrolyte platform and results in the one or more apertures formed in the slidable sleeve being open to the ingress of positive electrolyte.

34. The zinc-bromine flowing electrolyte battery of claim 33 wherein the ingress of positive electrolyte through the one or more apertures causes positive electrolyte to pass along the flow tube thereby causing the entry of complexed bromine through the complexed bromine inlet.

35. (canceled)

36. (canceled)

37. (canceled)

38. A method of regulating the flow of complexed bromine within a positive electrolyte circulation path of a zinc-bromine flowing electrolyte battery including the steps of:
(a) activating one of a negative electrolyte pump or a positive electrolyte pump;
(b) subsequently activating the electrolyte pump which was not activated in step (a); and
wherein the choice of which of the negative electrolyte pump or the positive electrolyte pump is activated first determines whether a positive electrolyte only or a positive electrolyte and complexed bromine mix are circulated within the positive electrolyte circulation path.

39. (canceled)
